(19) United States
(12) Patent Application Publication
(10) Pub. No.: US 2010/0061387 A1
(43) Pub. Date: Mar. 11, 2010

(54) NETWORK SIGNAL AUTO SWITCHING DEVICE THAT PREVENTS INTERRUPTION OF WAN SIGNAL

(75) Inventor: Po-Jung Chen, Taoyuan City (TW)

Correspondence Address: Muncy, Geissler, Olds & Lowe, PLLC, P.O. BOX 1364, FAIRFAX, VA, 22038-1364, US

(73) Assignee: U.D. ELECTRONIC CORPORATION, Taoyuan City (TW)

(21) Appl. No.: 12/538,518

(22) Filed: Aug. 10, 2009

(30) Foreign Application Priority Data
Sep. 5, 2008 (TW) 097216140
May 27, 2009 (TW) 098209442

(51) Int. Cl. H04L 12/28

(52) U.S. Cl. 370/401

(57) ABSTRACT

For installation in an electronic apparatus, for example, computer, a network signal auto switching device is disclosed having a circuit module that has a plurality of signal I/O ports, transformers and an automatic switch device, the automatic switch device having a plurality of signal directioning components respectively electrically connected to the signal I/O ports and a switch operable to control close/open circuit status of the signal directioning components such that a user can control signal transmission from one first signal I/O port to a second signal I/O port directly for output.

This application claims the priority benefit of Taiwan patent application number 098209442 filed on May 27, 2009 and 097216140 filed on Sep. 5, 2008.

### BACKGROUND OF THE INVENTION

1. Field of the Invention

The present invention relates to network signal switching technology and more particularly, to a network signal auto switching device allows selective control of transmission of signal from a first I/O port through one signal directioning component to a second I/O port directly for output, and selective control of interconnection of electronic apparatus that are respectively connected to the I/O ports.

2. Description of the Related Art

Following fast development of communication technology, communication network equipments have also been well developed. WAN (Wide Area Network) and LAN (Local Area Network) are communication networks defined subject to their size. LAN is a computer network that covers a small physical area, like a home, office, or small group of buildings, such as a school, or an airport. WAN is a computer network covering a broad area (i.e., any network whose communications links cross metropolitan, regional, or national boundaries. Further, WANs are used to connect LANs and other types of networks together.

Further, a network switching device can be a network repeater (router or hub) used to connect computers together, forming a LAN. By means of the network switching device to convert WAN signal into LAN signal and to transmit LAN signal to the data processing units of the computers, the computers can be connected to the Internet, or interconnected to share resources. However, when the power of the external system or the power of the connected peripheral apparatus or the power of the internal devices failed, WAN signal cannot be converted into LAN signal, causing interruption of communication among the connected peripheral apparatus or between the LAN and the external WAN, and resulting in noise and signal interference, signal attenuation or packet loss.

Therefore, during establishment of a network, signal converting means is generally set between the front side of the network under establishment and the external system so that when the power of an internal equipment of the network failed, WAN signal can be directly processed through the signal converting means and then transmitted to an external system, avoiding signal interruption.

FIG. 8 illustrates a prior art signal switching architecture. According to this design, an auto switching component is set between the posterior side of a network port A and the posterior side of a network port B. When power supply is normal, a WAN signal is inputted through the network port A, and then filtered through a respective transformer, and then converted by a PHY IC chip into a LAN signal, and then the LAN signal is transmitted to the network port B through another transformer for output. In case of power failure, the auto switching component works to short the circuit between the network port A and the network port B, for enabling the WAN signal to be directly transmitted to the network port B for output without through the PHY IC chip, avoiding signal interruption. However, this prior art design still has drawbacks as follows:

1. The use of the expensive auto switching component greatly increases the cost of the system.

2. The auto switching component works to short the circuit between the network port A and the network port B and to transmit the inputted WAN signal to the network port B only when the power of the network port A fails. This design does not allow selection of working of the auto switching component to transmit the inputted WAN signal to the network port B during normal functioning of the network port A, narrowing the application of the auto switching component.

3. This design does not allow on/off switching of the auto switching component during normal functioning of the network port A. When computers are respectively connected to the network port A and the network port B, the aforesaid design does not allow the computer that is connected to the network port A to switch on/off the auto switching component for checking the functioning of the computer that is connected to the network port B.

### SUMMARY OF THE INVENTION

The present invention has been accomplished under the circumstances in view.

A network signal auto switching device in accordance with the present invention comprises a plurality of signal I/O ports, a signal directioning component electrically connected between each two adjacent signal I/O ports, and a switch operable to control close/open circuit status of the signal directioning components. Thus, the user can selectively control directioning of the signal of one first signal I/O port to the other signal I/O ports through the signal directioning components for selecting communication or checking functioning of electronic products that are respectively connected to the signal I/O ports.

### BRIEF DESCRIPTION OF THE DRAWINGS

FIG. 1 is a circuit block diagram of the preferred embodiment of the present invention.

FIG. 2 is a circuit diagram of the preferred embodiment of the present invention.

FIG. 3 is a partial view of the circuit diagram of the preferred embodiment of the present invention (I).

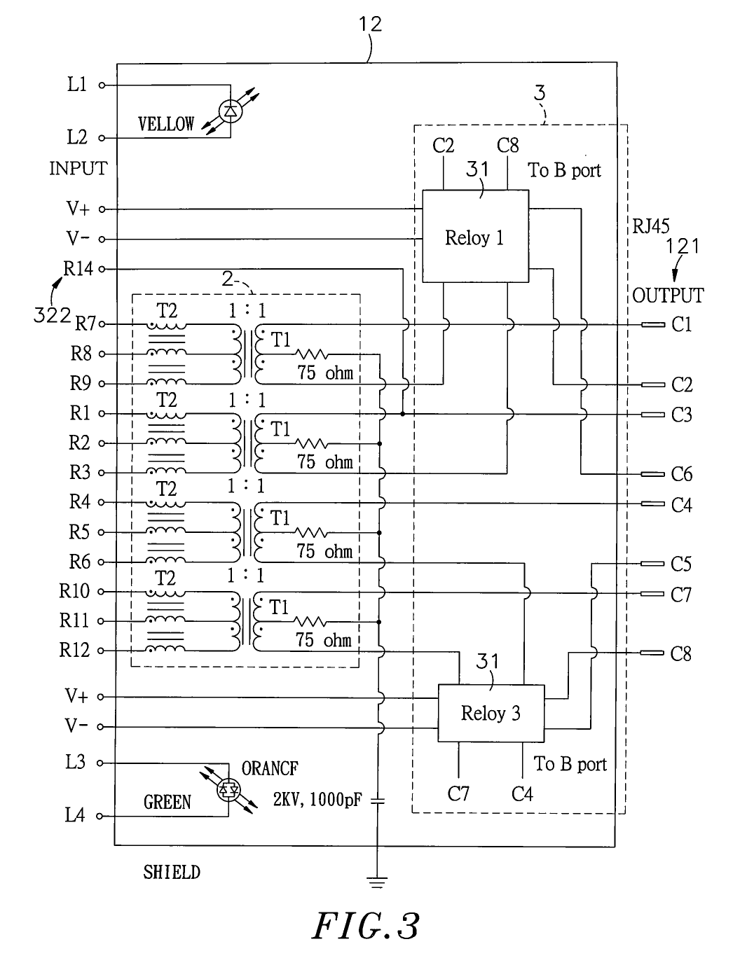

FIG. 4 is a partial view of the circuit diagram of the preferred embodiment of the present invention (II).

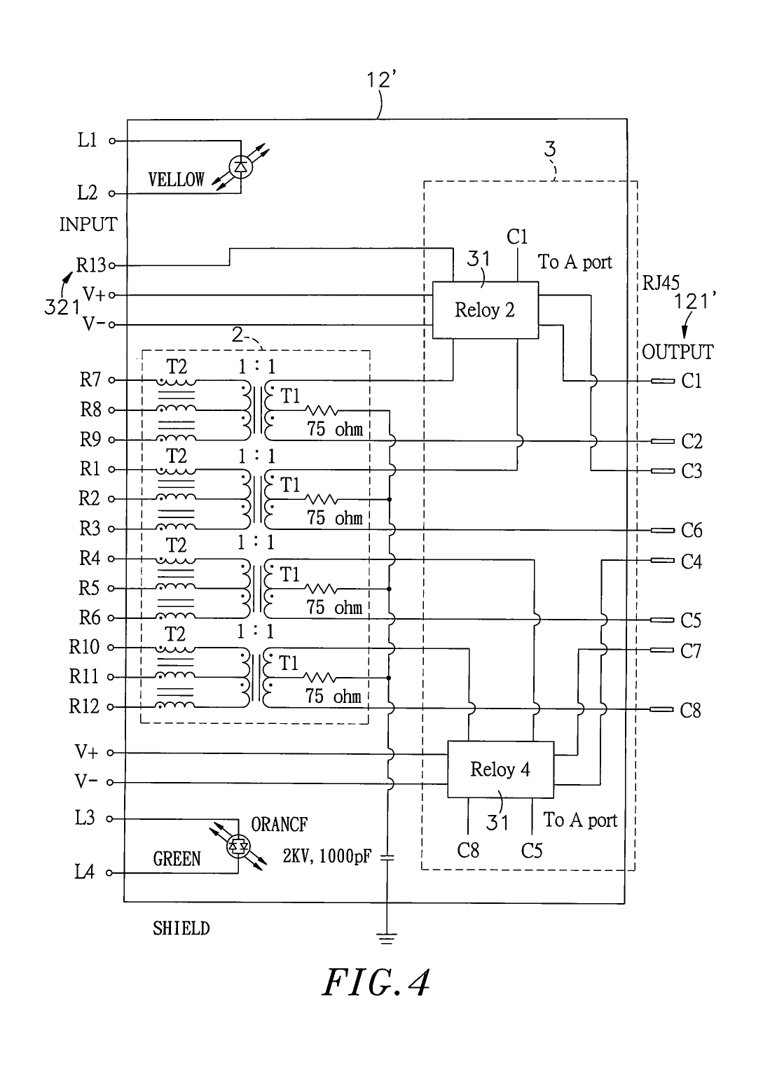

FIG. 5 is an elevational view of the preferred embodiment of the present invention.

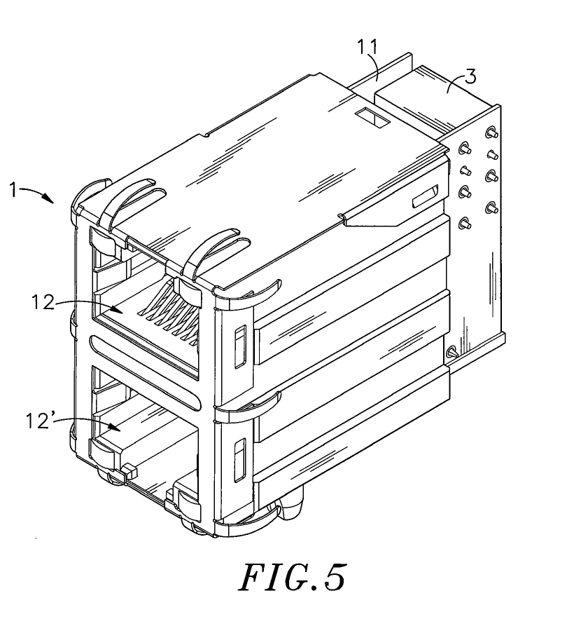

FIG. 6 is an elevational view of an alternate form of the present invention.

FIG. 7 is another elevational view of the alternate form shown in FIG. 6 when viewed from another angle.

FIG. 8 is a circuit block diagram of a prior art design.

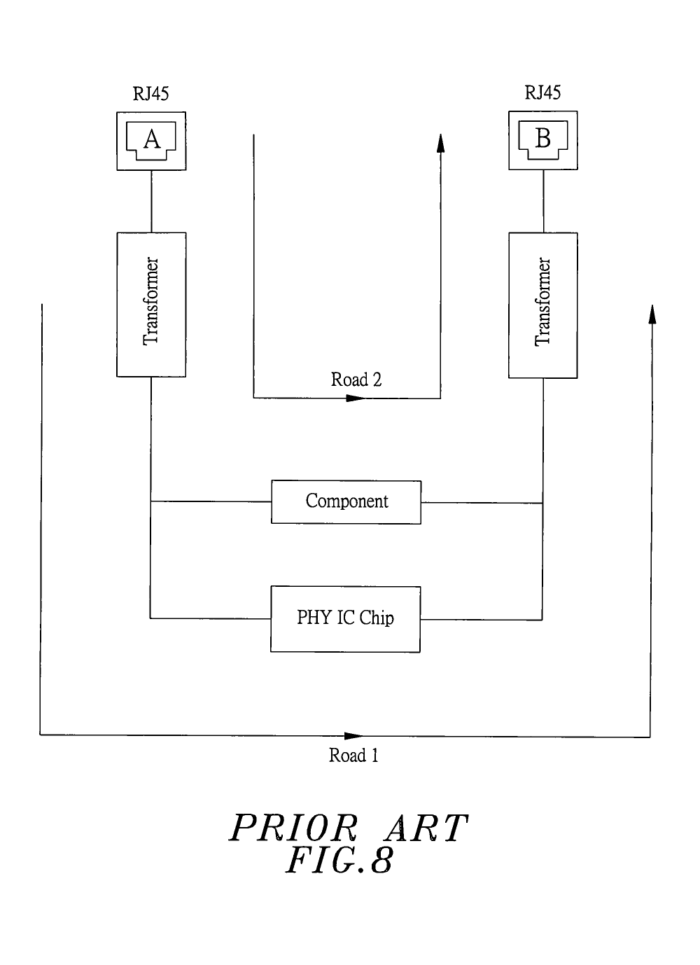

### DETAILED DESCRIPTION OF THE PREFERRED EMBODIMENT

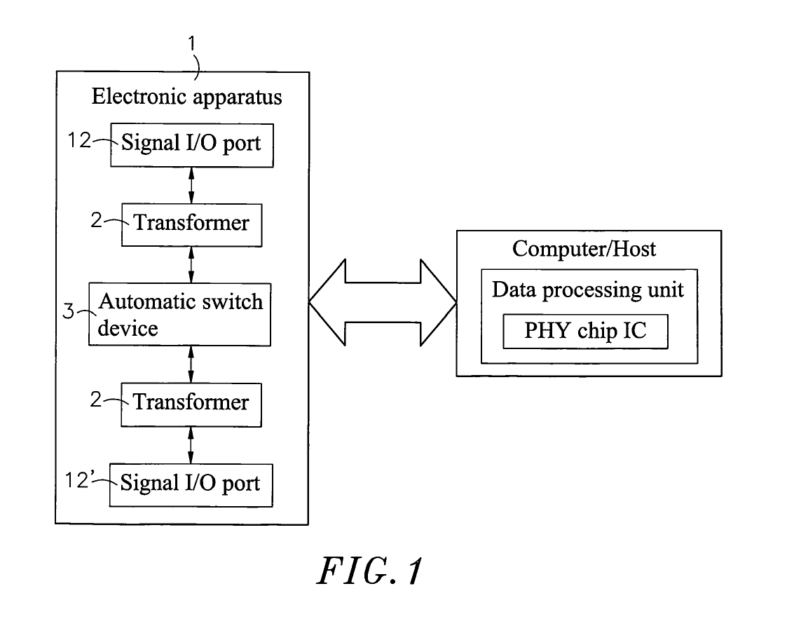

Referring to FIGS. 1˜5, a network signal auto switching device 1 having an auto-switching function to prevent network signal interruption is shown used in a computer/host (not shown).

The network signal auto switching device 1 has a circuit module 11 mounted therein. The circuit module 11 carries a plurality of electronic components, a plurality of, for example, two transformers 2, an automatic switch device 3 and a circuit layout. The circuit module 11 further has a plurality of, for example, two signal I/O ports 12 and 12′. Each signal I/O port 12 or 12′ has mounted therein a set of connection terminals 121 or 121′. Further, the network signal auto switching device 1 is covered with a metal shield, which is electrically connected to a grounding terminal of a motherboard in the computer for guiding surrounding electromagnetic waves and circuit module internal noises to the grounding terminal of the host computer for discharge.

The transformers 2 can be resistor type transformers, capacitive transformers or passive component type transformers respectively and electrically connected to the signal I/O ports 12 and 12′. Through the signal I/O ports 12 and 12′, the transformers 2 are electrically connected to the data processing unit on the motherboard of the computer to remove noises from an external network signal that is being transmitted to the data processing unit of the host computer. The data processing unit of the computer comprises a PHY IC chip and an oscillator, and is adapted for converting an external WAN (Wide Area Network) signal inputted through one signal I/O port 12 into a LAN (Local Area Network) signal for output through the other signal I/O port 12′.

The automatic switch device 3 is installed in the circuit module 11 of the network signal auto switching device 1 and electrically connected to the signal I/O ports 12 and 12′, comprising a plurality of signal directioning components 31 for controlling signal transmission direction, and a switch 32 for switching connection between the signal I/O ports 12 and 12′ and the signal directioning components 31. The switch 32 can be a relay, signal switch or any I/O controllable electronic component.

The signal directioning components 31 can be relays, signal routing chips, signal switches or any I/O controllable electronic components. According to the present preferred embodiment, the signal directioning components 31 are relays.

During application, signal cables are respectively connected to the signal I/O ports 12 and 12′ of the network signal auto switching device 1 and electrically connected with the connection terminals 121 and 121′. Thus, an external WAN signal can be transmitted through one signal I/O port 12 to the circuit module 11 where one transformer 2 removes noises from the WAN signal for enabling the WAN signal to be transmitted further to the data processing unit of the motherboard of the computer. Upon receipt of the WAN signal by the data processing unit, the PHY IC chip of the data processing unit of the computer converts the WAN signal into a corresponding LAN signal by, and the LAN signal is then filtered through the other transformer 2 and then outputted through the other signal I/O port 12′ and the associating signal cable.

Further, the automatic switch device 3 of the circuit module 11 of the network signal auto switching device 1 is electrically connected to the signal I/O ports 12 and 12′ to constitute a signal switching loop in which the signal directioning components 31 automatically switch into a close circuit status for enabling the external WAN signal to enter the connection terminals 121 (Output “C1˜C8”) of the first signal I/O port 12. When entered the connection terminals 121 (Output “C1˜C8”) of the first signal I/O port 12, the WAN signal is then converted into a corresponding LAN signal subject to the aforesaid procedure, and then transmitted to the second signal I/O port 12′ for output through the connection terminals 121′ (Output “C1˜C8”). In case of an interruption of the network signal auto switching device 1, the signal routing components 31 automatically switch into a close circuit status for enabling the external WAN signal to enter the connection terminals 121 (Output “C1˜C8”) of the first signal I/O port 12 and then to be directly transmitted by the signal directioning components 31 to the connection terminals 121′ (Output “C1˜C8”) of the second signal I/O port 12′, avoiding signal transmission interruption upon a short circuit, power failure or failure of the network signal auto switching device 1.

According to the present invention, the automatic switch device 3 and the transformers 2 are connected in parallel to the PHY IC chip of the data processing unit of the computer. However, this circuit arrangement is not a limitation. Further, the signal directioning components 31 can be set between the transformers 2 and the PHY IC chip. Alternatively, the signal directioning components 31 can be set between the transformers 2 and the signal I/O ports 12 and 12′ of the network signal auto switching device 1.

Further, the switch 32 of the automatic switch device 3 is operable to switch on/off the connection between the first signal I/O port 12 and the corresponding signal directioning component 31. Thus, when the network signal auto switching device 1 is functioning normally, the switch 32 can be switched on or off, either directly by hand or through a command (by means of applying a positive or negative voltage to switch on/off the switch 32), for enabling an input signal to be transmitted directly from the first signal I/O port 12 through one signal directioning component 31 to the second I/O port 12′ for output. Thus, the network signal auto switching device 1 can be preset to keep the signal directioning component 31 between the first signal I/O port 12 and the second signal I/O port 12′ in open-circuit status so that an external WAN signal can be transmitted through the first signal I/O port 12 to the data processing unit of the motherboard of the computer via the circuit module 11 and converted into a corresponding LAN signal for output through the second signal I/O port 12. When the signal directioning component 31 between the first signal I/O port 12 and the second signal I/O port 12′ is changed to close-circuit status subject to the control of the switch 32, an external WAN signal can be transmitted through the first signal I/O port 12 and the signal directioning component 31 between the first signal I/O port 12 and the second signal I/O port 12′ to the second signal I/O port 12′ for output into an external electronic device for test, checking functioning of the external electronic device that is connected to the second signal I/O port 12′. When an external WAN signal is transmitted from the first signal I/O port 12 to the second signal I/O port 12′ directly, the WAN signal is not processed through the transformers 2, avoiding signal attenuation and assuring signal transmission stability.

Further, the network signal auto switching device 1 has the signal I/O ports 12 and 12′, the transformers 2 and the automatic switch device 3 combined therein and arranged integrally in one same circuit module, saving much installation space in the computer, simplifying the arrangement of the control circuit and connection interface of the motherboard of the computer. Further, the switch 32 of the automatic switch device 3 can be mounted in the housing of the computer for manual operation by the user of the computer. The network signal auto switching device 1 can be made having a multiple signal I/O ports for the connection of multiple external electronic apparatus (computer, printer, etc.). Subject to the control of the automatic switch device 3, an external WAN signal can be through one signal I/O port and then directly outputted through either of the other signal I/O ports to the associating external electronic apparatus for checking signal receiving functioning of the associating external electronic apparatus. Thus, the invention is practical for use to test functioning of electronic apparatus.

Further, the signal I/O ports 12 and 12′ of the network signal auto switching device 1 can be RJ45 connection interfaces fitting Ethernet configurations for the connection of network apparatus. Further, the network signal auto switching device 1 can be a network connector or human-machine interface, or any of a variety of other I/O control interfaces. Further, the network signal auto switching device 1 can be made having multiple signal I/O ports 12 and 12′ arranged at different elevations, or horizontally aligned in a line. Further, the signal I/O ports 12 and 12′ can be made in integrity. Alternatively, the signal I/O ports 12 and 12′ can be made detachable.

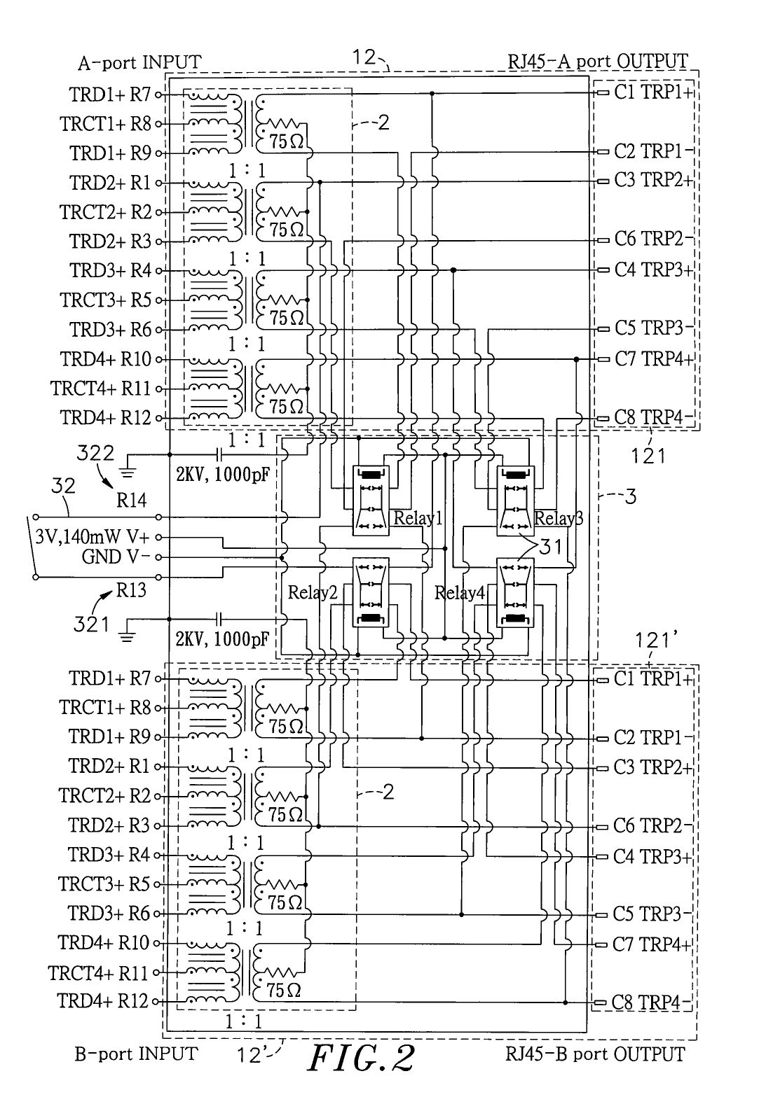

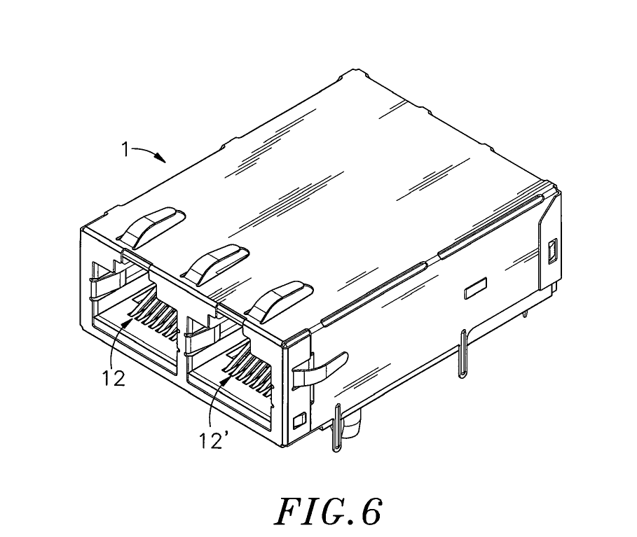

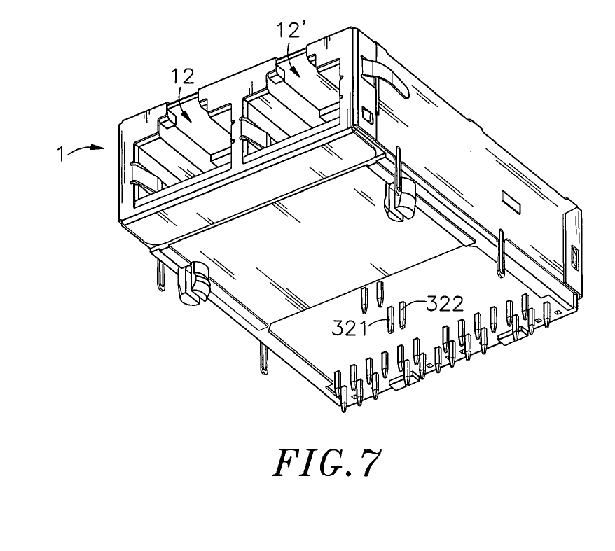

Referring to FIGS. 6 and 7 and FIG. 2 again, the network signal auto switching device 1 has two pins 321 and 322 downwardly protruding over the bottom wall. These two pins 321 and 322 are Input R13 and Input R14 for the connection of the two ends of the switch 32 respectively, for enabling Input R13 to be connected to the corresponding signal directioning component 31 and Input R14 to be connected to Output C3.

In conclusion, the main characteristic of the present invention is that the network signal auto switching device has a plurality of signal I/O ports 12 and 12′, a plurality of transformers 2 and an automatic switch device 31 electrically connected to the signal I/O ports 12 and 12′, wherein the automatic switch device 3 comprises a plurality of signal directioning components 31 respectively connected between each two adjacent ones of the signal I/O ports 12 and 12′, and a switch 32 for operation by a user to close/open the signal directioning components 31, for enabling a input signal to be transmitted from one of the signal I/O ports 12 and 12′ to another one of the signal I/O ports 12 and 12′ directly without through the transformers 2 so that the signal I/O ports 12 and 12′ can be used for testing functioning of electronic apparatus. Further, the signal directioning components 31 can use inexpensive relays, saving the cost.

As stated above, the invention to provide a network signal auto switching device with auto-switching function to prevent interruption of network signal, which has the following features and advantages:

1. The automatic switch device 3 is electrically connected with the signal I/O ports 12 and 12′ to form a signal switching loop. When an interruption of the network signal auto switching device 1 occurs, the signal directioning components 31 of the automatic switch device 3 are in close-circuit status for enabling an external WAN signal that enters one signal I/O port 12 to be guided to another signal I/O port 12′ for output without through signal conversion by the PHY IC chip of the data processing unit of the computer in which the network signal auto switching device 1 is installed, avoiding interruption of external WAN signal to paralyze the whole network system so that the network system keeps functioning normally upon failure of the network signal auto switching device 1.

2. The switch 32 of the automatic switch device 3 is operable to close/open the signal directioning component 31 between two adjacent signal I/O ports 12 and 12′, enabling an external signal to be directly transmitted between two external electronic apparatus that are respectively connected to the two adjacent signal I/O ports 12 and 12′ without through the computer which the network signal auto switching device 1 is installed.

3. The signal directioning components 31 can use inexpensive relays, saving the cost. When an interruption occurs in the network signal auto switching device 1, the external WAN signal can transmitted through the signal I/O ports 12 and 12′ via the signal directioning components 31 without passing through the transformers 2, avoiding signal attenuation and enhancing signal transmission stability.

A prototype of network signal auto switching device has been constructed with the features of FIGS. 1˜7. The network signal auto switching device functions smoothly to provide all of the features disclosed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A network signal auto switching device installed in an electronic apparatus, said network signal auto switching device comprising a circuit module, said circuit module comprising a plurality of signal I/O ports, a plurality of transformers and an automatic switch device,
wherein said automatic switch device comprises a plurality of signal directioning components respectively electrically connected to said signal I/O ports, and a switch operable to control close/open circuit status of said signal directioning components.

2. The network signal auto switching device as claimed in claim 1, wherein said signal directioning components are switched to close-circuit status to form with one first signal I/O port of said signal I/O ports a signal switching loop upon an interruption of said electronic apparatus, for enabling WAN signal to be converted into LAN signal and transmitted to a second signal I/O port of said signal I/O ports for output.

3. The network signal auto switching device as claimed in claim 1, wherein said signal directioning components and said transformers are connected in parallel to a PHY IC chip of a motherboard said electronic apparatus.

4. The network signal auto switching device as claimed in claim 1, wherein said switch of said automatic switch device is a manual switch mounted on housing of said electronic apparatus in which the network signal auto switching device is installed.

5. The network signal auto switching device as claimed in claim 1, wherein said transformers are respectively electrically connected between said signal I/O ports and a PHY IC chip of a motherboard of said electronic apparatus for removing noises from external WAN signal.

6. The network signal auto switching device as claimed in claim 1, wherein said signal I/O ports are RJ-45 connectors made subject to Ethernet configurations.

7. The network signal auto switching device as claimed in claim 1, wherein said signal directioning components are relays.

8. The network signal auto switching device as claimed in claim 1, wherein said signal directioning components are signal switches.
